(19) United States
(12) Patent Application Publication
(10) Pub. No.: US 2007/0283392 A1
(43) Pub. Date: Dec. 6, 2007

(54) Program Selecting System

(76) Inventors: Yuko Tsusaka, Osaka (JP); Keiji Icho, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/587,385

(22) PCT Filed: Apr. 27, 2005
(86) PCT No.: PCT/JP05/07983

§ 371 Date: Jul. 12, 2007

(30) Foreign Application Priority Data
Apr. 28, 2004 (JP) 2004-134517

(51) Int. Cl. H04N 5/445

(52) U.S. Cl. 725/47

(57) ABSTRACT

A program selecting system includes a playback device and a server. During playback of a program, the playback device transmits a program identifier for identifying the program, an evaluation of the program by a viewer, and an attribute of the viewer to the server. The server totalizes evaluations of programs according to viewer attribute and stores evaluation totals. When requested by the playback device, the server transmits program identifiers of programs which are highly evaluated by other viewers having similar attributes to the viewer, and evaluation totals of the programs. The playback device displays ranking of the programs based on the received evaluation totals.

### TECHNICAL FIELD

The present invention relates to information provision techniques that are useful for program selection when viewing broadcast programs and recorded programs, and especially relates to techniques of providing information about programs which suit preferences of a viewer.

### BACKGROUND ART

In recent years, as a result of the development of broadcasting technologies, a wide variety of programs are broadcast on a large number of channels not only by terrestrial broadcasting but also by CATV (Cable Television), satellite broadcasting, and the like. Also, as a result of the development of recording technologies, a large number of programs are automatically recorded onto a large-capacity storage medium.

In such a situation where many programs are available for viewing, there is a technique of selecting programs and program segments which suit preferences of a viewer based on program-related information such as an EPG (Electric Program Guide) transmitted together with video, audio, etc. of programs, and presenting and automatically recording the selected programs and program segments. Also, there is a technique of assessing the preferences of the viewer based on his/her viewing history, in order to select programs that better suit the preferences of the viewer and present and automatically record the selected programs.

These techniques help the viewer choose a program which he/she wants to watch, from hundreds and thousands of programs.

### DISCLOSURE OF THE INVENTION

Problems the Invention is Going to Solve

According to the above techniques, however, the program selection is performed based on personal information of the viewer such as sex and viewing history information showing which genres of programs the viewer has watched in the past. This being so, similar types of programs tend to be always selected unless there is a major change in viewing history.

Also, given the difference between what the viewer watched and what he/she found interesting, the program selection based merely on the viewing history information and the personal information cannot sufficiently reflect the preferences of the viewer.

In view of this, the present invention aims to provide a program selecting system for selecting and presenting recommended programs that better reflect preferences of a viewer.

Means of Solving the Problems

The stated aim can be achieved by a program selecting system including a server device and a plurality of playback devices, the server device including: an acquisition unit operable to acquire, from each playback device, a program identifier for identifying a program being played back, an elapsed time information piece showing an elapsed time from a start of the program, an evaluation of the program by a viewer, and attribute information showing an attribute of the viewer; a storage unit operable to store, for each of a plurality of viewer types based on attributes, evaluation totals in correspondence with program identifiers and elapsed time information pieces, each evaluation total being a result of totalizing evaluations acquired together with a corresponding program identifier and elapsed time information piece; a specific attribute acquisition unit operable to acquire specific attribute information; a selection unit operable to select program identifiers and elapsed time information pieces stored in the storage unit for a viewer type determined by the specific attribute information; and a transmission unit operable to transmit the selected program identifiers and elapsed time information pieces, and evaluation totals corresponding to the selected program identifiers and elapsed time information pieces, and each playback device including.: a playback unit operable to play back the program; a transmitting unit operable to transmit, while the program is being played back, the program identifier, the elapsed time information piece, the evaluation, and the attribute information to the server device; a specific attribute transmission unit operable to transmit the specific attribute information; a program acquisition unit operable to acquire, from the server device, the program identifiers and elapsed time information pieces selected in relation to the specific attribute information, and the evaluation totals corresponding to the selected program identifiers and elapsed time information pieces; and a display unit operable to display the acquired program identifiers and elapsed time information pieces, in an order based on the acquired evaluation totals.

### EFFECTS OF THE INVENTION

According to the above construction, when selecting a program, the viewer can be presented with evaluations of programs by other viewers who have same attributes as the viewer in terms of preferences and the like. If someone who has similar preferences to the viewer has already viewed a program, the viewer can know how the program is evaluated by others, before deciding whether to view the program.

By displaying evaluations of programs such as by showing program titles in descending order of positive response, the viewer can select and view a program that better suits his/her preferences.

Also, the viewer may even select and view a program which he/she would not have selected before, if that program is highly evaluated by other viewers having similar preferences to the viewer. This provides wider program selection, with it being possible to help the viewer not miss programs which suit his/her preferences.

In the server device, the acquisition unit operable to acquire the program identifier and the like is realized by a ranking generation unit 5400 and a transmission/reception unit 5700 shown in FIG. 5. The storage unit operable to store the evaluation totals is realized by an overall ranking information storage unit 5500. The specific information acquisition unit operable to acquire the specific attribute information is realized by a ranking information extraction unit 5600 and the transmission/reception unit 5700. The selection unit operable to select the program identifiers and the like is realized by the ranking information extraction unit 5600. The transmission unit operable to transmit the selected program identifiers and the like is realized by the ranking information extraction unit 5600 and the transmission/reception unit 5700.

In the playback device, the playback unit operable to play back the program is realized by a program recording/playback unit 1020 shown in FIG. 4. The transmitting unit operable to transmit the program identifier and the like to the server device is realized by an evaluation information input unit 1400, a profile information storage unit 1500, a program information storage unit 1600, and a transmission/reception unit 1900. The specific information transmission unit operable to transmit the specific attribute information is realized by the profile information storage unit 1500 and the transmission/reception unit 1900. The program acquisition unit operable to acquire the selected program identifiers and the like from the server device is realized by a ranking information storage unit 1700 and the transmission/reception unit 1900. The display unit operable to display the acquired program identifiers and the like is realized by a program selection unit 1800 and a ranking display unit 1200.

The stated aim can also be achieved by a program playback device including: a playback unit operable to play back a program; a transmitting unit operable to transmit, while the program is being played back, a program identifier for identifying the program, an elapsed time information piece showing an elapsed time from a start of the program, an evaluation of the program by a viewer, and attribute information showing an attribute of the viewer, to an external device that collects program identifiers, elapsed time information pieces, evaluations, and attribute information from a plurality of playback devices including the program playback device; an acquisition unit operable to acquire, from the external device, program identifiers and elapsed time information pieces that relate to the attribute information, and evaluations corresponding to the program identifiers and elapsed time information pieces that relate to the attribute information; and a display unit operable to display the acquired program identifiers and elapsed time information pieces, in an order based on the acquired evaluations.

According to this construction, the program playback device transmits an evaluation of a currently viewed program and an attribute of the viewer such as preferences, to a server. The program playback device receives evaluations of programs by other viewers who have similar attributes to the viewer in terms of preferences and the like, and displays program titles and the like according to the evaluations. This allows the viewer to select a program that better suits his/her preferences.

Also, the program evaluation and the recommended program display can be performed by the same playback device. This makes it possible to collect evaluations from a large number of viewers.

Here, the program playback device may further include: a recording unit operable to record a program to a storage medium, wherein if a program identified by any of the acquired program identifiers has already been recorded by the recording unit, the display unit displays, together with the program identifier, information that the program identified by the program identifier has already been recorded.

According to this construction, the viewer can know which of the recommended programs has already been recorded. Hence the viewer can watch the program instantly, with there being no need to check whether the program has already been recorded or not.

The recording unit operable to record the program to the storage medium is realized by the program recording/playback unit 1020 shown in FIG. 4.

Here, the program playback device may further include: a playback instruction unit operable to choose a program identifier and an elapsed time information piece from the display by the display unit, and obtain a playback instruction, wherein the playback unit starts playing back a program identified by the chosen program identifier, from a point specified by the chosen elapsed time information piece relative to a start of the program.

According to this construction, the viewer can know which portion of a recommended program is highly evaluated by other viewers who have similar attributes to the viewer in terms of preferences and the like, based on the elapsed time information piece. Hence the viewer can watch the program from the highly evaluated portion, rather than from the beginning of the program. The portion referred to here is the so-called segment in the program, and the point specified by the elapsed time information piece is the beginning of the segment.

The playback instruction unit operable to acquire the playback instruction is realized by a user interface unit 1010 shown in FIG. 4.

Here, the program playback device may further include: an attribute display unit operable to display the attribute information; an attribute edition unit operable to edit the attribute information displayed by the attribute display unit; and an edited attribute transmission unit operable to transmit the edited attribute information to the external device, wherein the acquisition unit acquires, from the external device, program identifiers and elapsed time information pieces that relate to the edited attribute information, and evaluations corresponding to the program identifiers and elapsed time information pieces that relate to the edited attribute information.

Here, the attribute display unit may quantify the attribute information and display the quantified attribute information in a chart.

According to these constructions, the viewer can know what kinds of programs are evaluated by viewers whose profiles are different from that of the viewer. This gives the viewer an opportunity to watch a program highly evaluated by other viewers, without being constrained by his/her viewing tendency. Hence wider program selection can be achieved.

The attribute display unit operable to display the attribute information and the attribute edition unit operable to edit the displayed attribute information are realized by a profile information display/edition unit 1100 shown in FIG. 4. The edited attribute transmission unit operable to transmit the edited attribute information is realized by the profile information storage unit 1500 and the transmission/reception unit 1900.

Here, the program selecting system may further include a chat server, wherein each playback device further includes: a chat window used to perform a chat about the program being played back; and a text input device, if a chat room for the program has not been hosted, the chat server hosts the chat room, and the evaluation is an amount of conversation made in the chat.

According to this construction, the viewer's desire to talk about the currently viewed program with other viewers is regarded as his/her evaluation of the program. This makes it possible to reflect not only the viewer's rating of the program but also the viewer's interest level of the program, onto his/her evaluation. This makes it possible to recommend programs that better reflect the viewing tendency of the viewer. As a result, programs that better suit the preferences of the viewer can be selected.

The chat server is realized by a chat server unit 5950 shown in FIG. 5. The chat window is realized bay chat display unit 1950 shown in FIG. 4. The text input device is realized by the user interface unit 1010 or other input media.

The stated aim can also be achieved by a server device including: an acquisition unit operable to acquire, from each of a plurality of playback devices, a program identifier for identifying a program being played back, an elapsed time information piece showing an elapsed time from a start of the program, an evaluation of the program by a viewer, and attribute information showing an attribute of the viewer; a storage unit operable to store, for each of a plurality of viewer types based on attributes, evaluation totals in correspondence with program identifiers and elapsed time information pieces, each evaluation total being a result of totalizing evaluations acquired together with a corresponding program identifier and elapsed time information piece; a specific attribute acquisition unit operable to acquire specific attribute information; a selection unit operable to select program identifiers and elapsed time information pieces stored in the storage unit for a viewer type determined by the specific attribute information; and a transmission unit operable to transmit the selected program identifiers and elapsed time information pieces.

The stated aim can also be achieved by a program display method used in a device for playing back a program, including steps of: playing back a program; transmitting, while the program is being played back, a program identifier for identifying the program, an elapsed time information piece showing an elapsed time from a start of the program, an evaluation of the program by a viewer, and attribute information showing an attribute of the viewer, to an external device that collects program identifiers, elapsed time information pieces, evaluations, and attribute information from a plurality of playback devices including the device; acquiring, from the external device, program identifiers and elapsed time information pieces that relate to the attribute information, and evaluations corresponding to the program identifiers and elapsed time information pieces that relate to the attribute information; and displaying the acquired program identifiers and elapsed time information pieces, in an order based on the acquired evaluations.

The stated aim can also be achieved bay computer program for causing a device for playing back a program to perform a program display operation, the program display operation including steps of: playing back a program; transmitting, while the program is being played back, a program identifier for identifying the program, an elapsed time information piece showing an elapsed time from a start of the program, an evaluation of the program by a viewer, and attribute information showing an attribute of the viewer, to an external device that collects program identifiers, elapsed time information pieces, evaluations, and attribute information from a plurality of playback devices including the device; acquiring, from the external device, program identifiers and elapsed time information pieces that relate to the attribute information, and evaluations corresponding to the program identifiers and elapsed time information pieces that relate to the attribute information; and displaying the acquired program identifiers and elapsed time information pieces, in an order based on the acquired evaluations.

The stated aim can also be achieved by a computer program for causing a server device to perform a program management operation, the program management operation including steps of: acquiring, from each of a plurality of playback devices, a program identifier for identifying a program being played back, an elapsed time information piece showing an elapsed time from a start of the program, an evaluation of the program by a viewer, and attribute information showing an attribute of the viewer; storing, for each of a plurality of viewer types based on attributes, evaluation totals in correspondence with program identifiers and elapsed time information pieces, each evaluation total being a result of totalizing evaluations acquired together with a corresponding program identifier and elapsed time information piece; acquiring specific attribute information; selecting program identifiers and elapsed time information pieces stored for a viewer type determined by the specific attribute information; and transmitting the selected program identifiers and elapsed time information pieces.

The stated aim can also be achieved by an integrated circuit for a playback device for playing back a program, including: a transmitting unit operable to transmit, while a program is being played back, a program identifier for identifying the program, an elapsed time information piece showing an elapsed time from a start of the program, an evaluation of the program by a viewer, and attribute information showing an attribute of the viewer, to an external device that collects program identifiers, elapsed time information pieces, evaluations, and attribute information from a plurality of playback devices including the playback device; an acquisition unit operable to acquire, from the external device, program identifiers and elapsed time information pieces that relate to the attribute information, and evaluations corresponding to the program identifiers and elapsed time information pieces that relate to the attribute information; and a display unit operable to display the acquired program identifiers and elapsed time information pieces, in an order based on the acquired evaluations.

The stated aim can also be achieved by an integrated circuit for a server device, including: an acquisition unit operable to acquire, from each of a plurality of playback devices, a program identifier for identifying a program being played back, an elapsed time information piece showing an elapsed time from a start of the program, an evaluation of the program by a viewer, and attribute information showing an attribute of the viewer; a storage unit operable to store, for each of a plurality of viewer types based on attributes, evaluation totals in correspondence with program identifiers and elapsed time information pieces, each evaluation total being a result of totalizing evaluations acquired together with a corresponding program identifier and elapsed time information piece; a specific attribute acquisition unit operable to acquire specific attribute information; a selection unit operable to select program identifiers and elapsed time information pieces stored in the storage unit for a viewer type determined by the specific attribute information; and a transmission unit operable to transmit the selected program identifiers and elapsed time information pieces.

According to these constructions, the playback device and the server device of the present invention can be realized. As a result, the program selecting system can easily be constructed.

### BRIEF DESCRIPTION OF THE DRAWINGS

FIG. 1 shows an overall program selecting system.

FIG. 2 shows an example of a program list screen displayed on a display of a recording/playback device.

FIG. 3 shows an example display of a profile screen 2100.

FIG. 4 is a functional block diagram showing a construction of the recording/playback device.

FIG. 5 is a functional block diagram showing a construction of a service provision device.

FIG. 6 shows a structure and a specific example of program information.

FIG. 7 shows a structure and a specific example of segment information.

FIG. 8 shows a structure and a specific example of profile information.

FIG. 9 shows a structure and a specific example of profile type information.

FIG. 10 shows a structure and a specific example of a profile type list.

FIG. 11 shows a structure and a specific example of profile chart information.

FIG. 12 shows a structure and a specific example of evaluation information.

FIG. 13 shows a structure and a specific example of overall ranking information.

FIG. 14 shows a structure and a specific example of ranking information.

FIG. 15 shows a structure and a specific example of recorded program information.

FIG. 16 is a flowchart showing an operation of reflecting the viewer's fun button presses, onto program ranking.

FIG. 17 is a flowchart showing an operation of displaying a program list screen 2000, editing a profile, and redisplaying a program ranking screen 2200.

FIG. 18 is a flowchart showing an operation of performing a chat.

### DESCRIPTION OF REFERENCE NUMERALS

1000 . . . recording/playback device

1100 . . . profile information display/edition unit

1200 . . . ranking display unit

1300 . . . schedule recorded program display

1300 . . . schedule recorded program display unit

1400 . . . evaluation information input unit

1410 . . . evaluation information

1500 . . . profile information storage unit

1510 . . . profile information

1520 . . . profile chart information

1600 . . . program information storage unit

1610 . . . recorded program information

1700 . . . ranking information storage unit

1710 . . . ranking information

1800 . . . program selection unit

1900 . . . transmission/reception unit

1950 . . . chat display unit

2000 . . . program list screen

2100 . . . profile screen

2200 . . . program ranking screen

2300 . . . schedule recording screen

2950 . . . chat screen

4000 . . . network

5000 . . . service provision device

5100 . . . overall profile information storage unit

5150 . . . profile type information

5160 . . . profile type list

5200 . . . profile information collection unit

5400 . . . ranking generation unit

5500 . . . overall ranking information storage unit

5510 . . . overall ranking information

5600 . . . ranking information extraction unit

5700 . . . transmission/reception unit

5800 . . . program information storage unit

5950 . . . chat server unit

8000 . . . signal

9000 . . . broadcast station

9100 . . . program information

9200 . . . segment information

### BEST MODE FOR CARRYING OUT THE INVENTION

<Overview>

A program selecting system according to the present invention collects evaluations of programs by many viewers and profiles which include personal information and viewing tendencies of the viewers, selects programs that suit preferences of a viewer based on the collected evaluations and profiles, andpresents the selected programs to the viewer.

In detail, the program selecting system selects, as recommendations to a viewer, programs having high rates of being found interesting by other viewers who have similar profiles to the viewer.

Such selection is made from programs that include both a program which is scheduled to be broadcast for viewing by the viewer and a program which has already been broadcast. A reason for this is given below.

The program which is scheduled to be broadcast may later be rebroadcast or its broadcast date and time may be delayed depending on region. Therefore, the selection can be made based on evaluations by other viewers who watched the program in the past. Also, the program which has already been broadcast can easily viewed if it has been recorded by a recording device. Even if the program has not been recorded, the program can still be viewed through video rental, the Internet, or the like.

Also, the program selecting system displays the profile of the viewer in the form of a chart, and receives edits on the chart. The program selecting system then presents recommended programs corresponding to viewers having the edited profile, to the viewer. This enables the viewer to know what kinds of programs are highly evaluated by viewers whose profiles are different from his/her profile. In this way, wider program selection can be achieved.

Furthermore, the program selecting system enables the viewer to perform a chat about a program with other viewers who are watching the same program, and uses an amount of conversation made in the chat as an evaluation of that program.

<Construction>

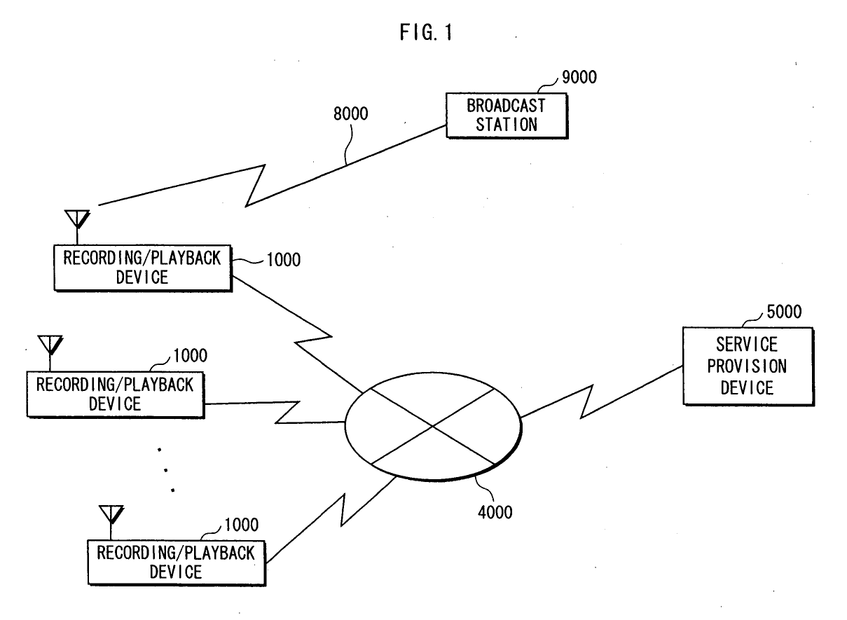

The following describes the program selecting system according to the present invention, with reference to FIGS. 1 to 4.

FIG. 1 shows the overall program selecting system.

Each of a plurality of recording/playback devices 1000 is a personal recording/playback device intended for home use. The recording/playback device 1000 receives a signal 8000 from a broadcast station 9000, and performs an operation such as recording. The recording/playback device 1000 has a network function, in addition to a general recording/playback function.

Also, the recording/playback device 1000 includes a display for displaying a program.

A service provision device 5000 acts as a server device in the program selecting system. The service provision device 5000 has functions such as collecting data from the plurality of recording/playback devices 1000 which act as clients in the program selecting system, conducting operations such as management and processing of the collected data, and transmitting data in response to a request from any of the plurality of recording/playback devices 1000.

The plurality of recording/playback devices 1000 are connected to the service provision device 5000 via a network 4000.

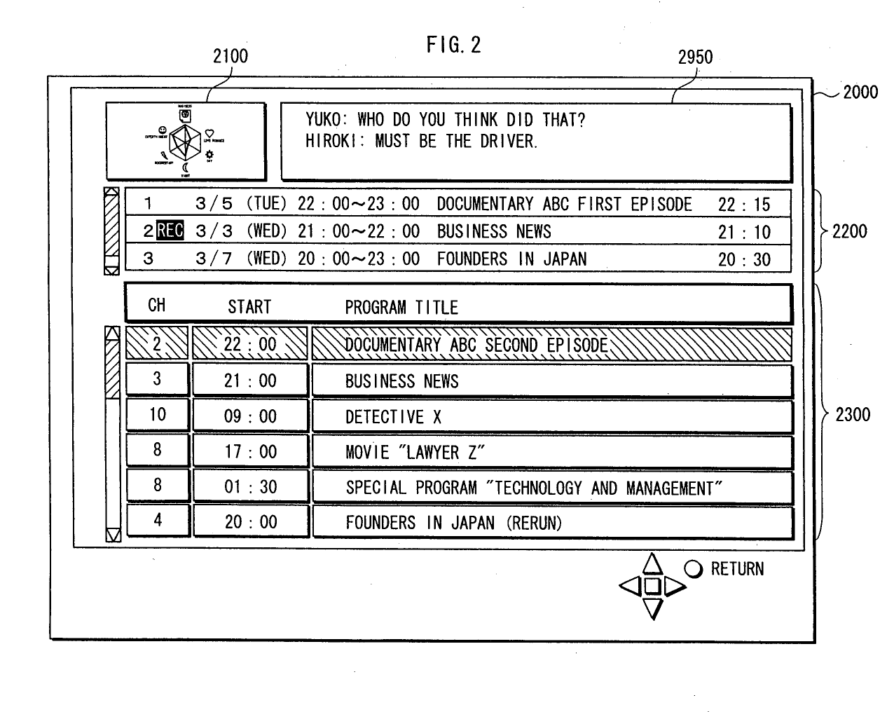

FIG. 2 shows a program list screen displayed on the display of the recording/playback device 1000.

A program list screen 2000 is smaller than a screen size of the display, and is overlaid on video which is being shown on the display.

The program list screen 2000 includes four sub-screens.

These four sub-screens are a profile screen 2100, a program ranking screen 2200, a schedule recording screen 2300, and a chat screen 2950.

The profile screen 2100 is shown in the form of a chart so that the profile of the viewer can be recognized visually. The chart of the profile being displayed can be edited by the viewer to change his/her profile.

The program ranking screen 2200 shows ranking of recommended programs which are found as interesting by other viewers, in descending order of evaluation.

The mark “REC” on the left side of a date of a ranked program indicates that the program has already been recorded. A time shown on the right side of a program title, such as “20:30” on the right side of the program title “Founders in Japan”, indicates that a portion of the program from 20:30 is rated highest by other viewers. Note here that a recorded program can be played back from a point at which the program is rated highest by other viewers. For instance, the program “Founders in Japan” can be played back from a point corresponding to a broadcast time 20:30.

The schedule recording screen 2300 shows a list of programs which are scheduled to be recorded from today on.

The programs shown on the schedule recording screen 2300 include a program which is selected as suiting the preferences of the viewer based on his/her viewing history, and a program which is shown on the program ranking screen 2200 or its rerun or sequel.

The chat screen 2950 is a screen used for the viewer to perform a chat with another viewer who is viewing a same program.

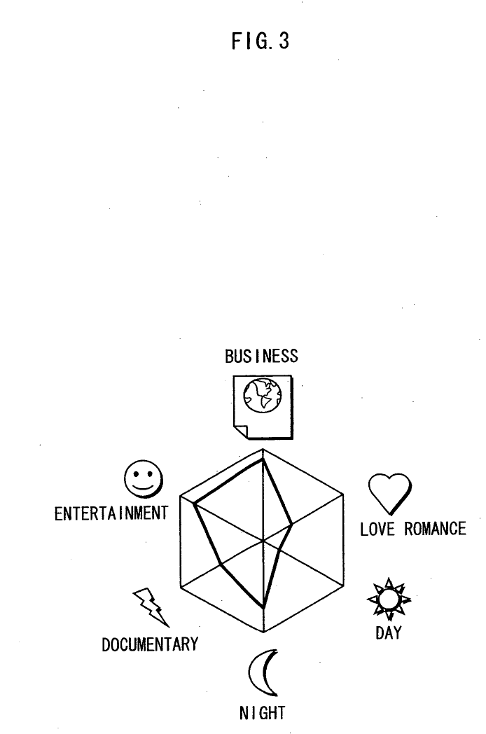

FIG. 3 shows an example display of the profile screen 2100.

The profile screen 2100 shows a program viewing tendency of the viewer in the form of a chart, based on his/her viewing history and the like. In this embodiment, the profile screen 2100 shows a radar chart in which a data point is located farther from a center point when a corresponding genre tends to be watched by the viewer more frequently. For example, the viewer having this profile has a high tendency of viewing business programs.

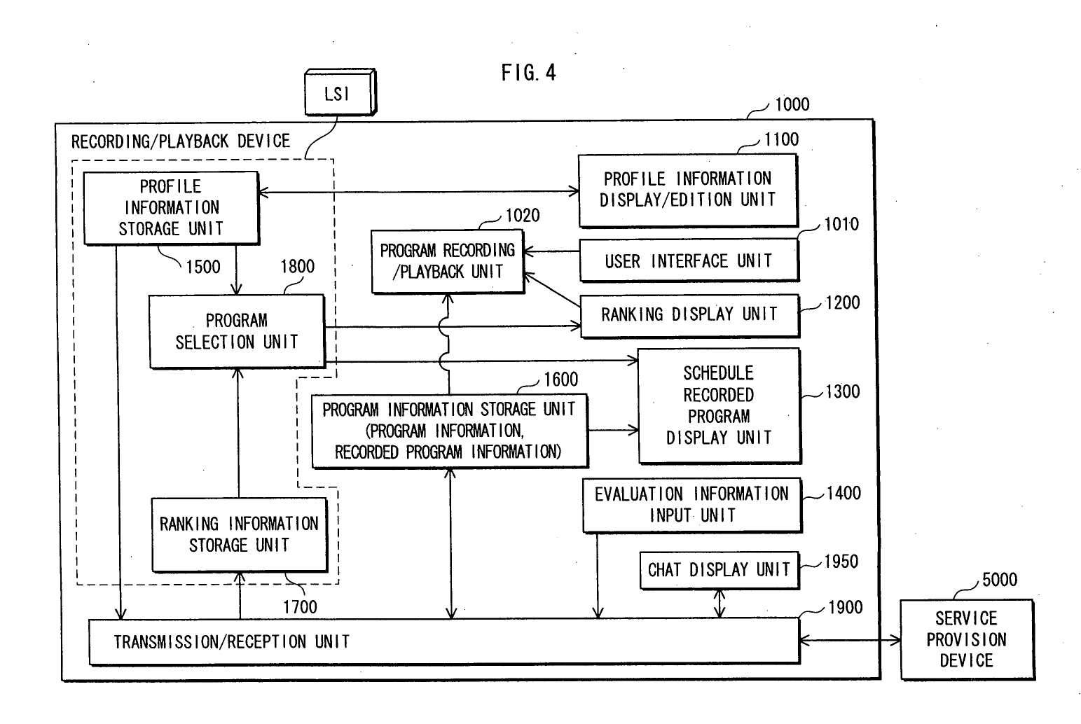

FIG. 4 is a functional block diagram showing a construction of the recording/playback device.

The recording/playback device 1000 includes a user interface unit 1010, a program recording/playback unit 1020, a profile information display/edition unit 1100, a ranking display unit 1200, a schedule recorded program display unit 1300, an evaluation information input unit 1400, a chat display unit 1950, a profile information storage unit 1500, a program information storage unit 1600, a ranking information storage unit 1700, a program selection unit 1800, and a transmission/reception unit 1900.

Each function of the recording/playback device 1000 can be realized by a CPU executing a program stored on a memory or a hard disk (not illustrated) in the recording/playback device 1000.

As shown in FIG. 4, the program selection unit 1800, the profile information storage unit 1500, and the ranking information storage unit 1700 are formed by an integrated circuit.

The recording/playback device 1000 has a function of storing the program viewing history of the viewer and updating the profile of the viewer according to the program viewing history, and a function of automatically selecting and schedule recording a program which suits the preferences of the viewer based on the profile. Note that these functions are not shown in the drawing.

The user interface unit 1010 and the program recording/playback unit 1020 have same functions as general recording/playback devices. In detail, the user interface unit 1010 has a function of receiving an input from a general input medium such as a remote control, and the program recording/playback unit 1020 has a function of playing/recording a received program.

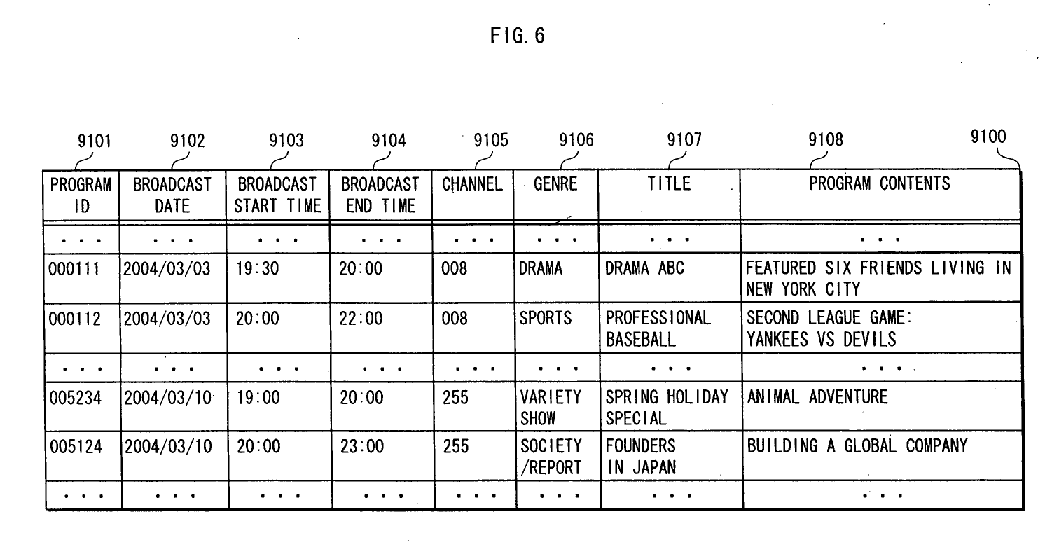

The following explains each of the storage units. Details of information stored in these storage units will be explained later in the <Data> section, with reference to FIGS. 6 to 15.

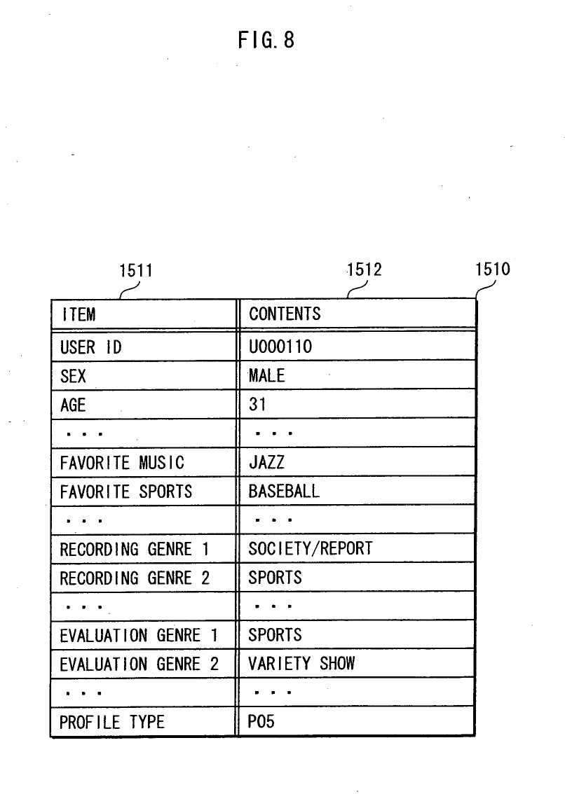

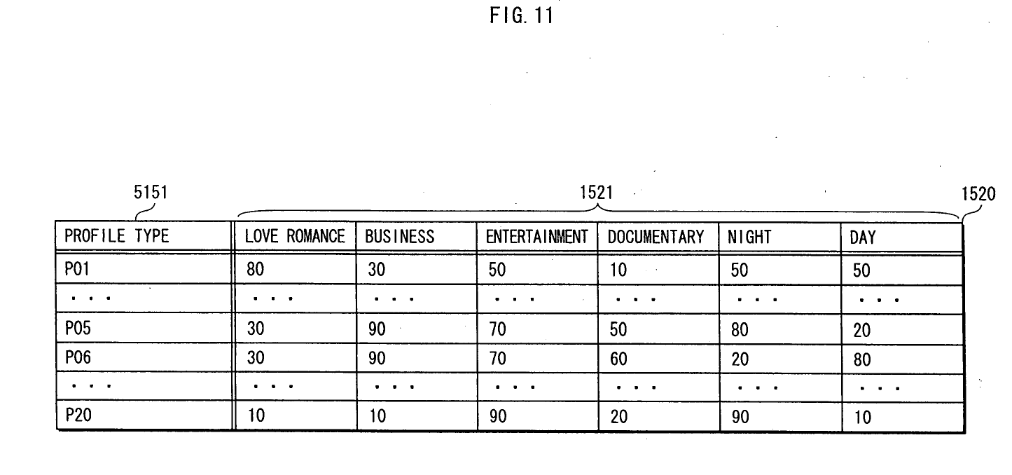

The profile information storage unit 1500 has a function of storing profile information 1510 (see FIG. 8) of the viewer and profile chart information 1520 (see FIG. 11).

Here, the number of sets of profile information 1510 stored in the profile information storage unit 1500 is one, i.e. the profile information of the viewer of the recording/playback device 1000. In the case where there are two or more viewers of the recording/playback device 1000 depending on a family structure or the like, a plurality of sets of profile information are stored in the profile information storage unit 1500 and a profile is selected according to circumstances. In this embodiment, however, the number of viewers is assumed to be one.

The profile chart information 1520 is used for displaying the profile of the viewer in the form of a chart.

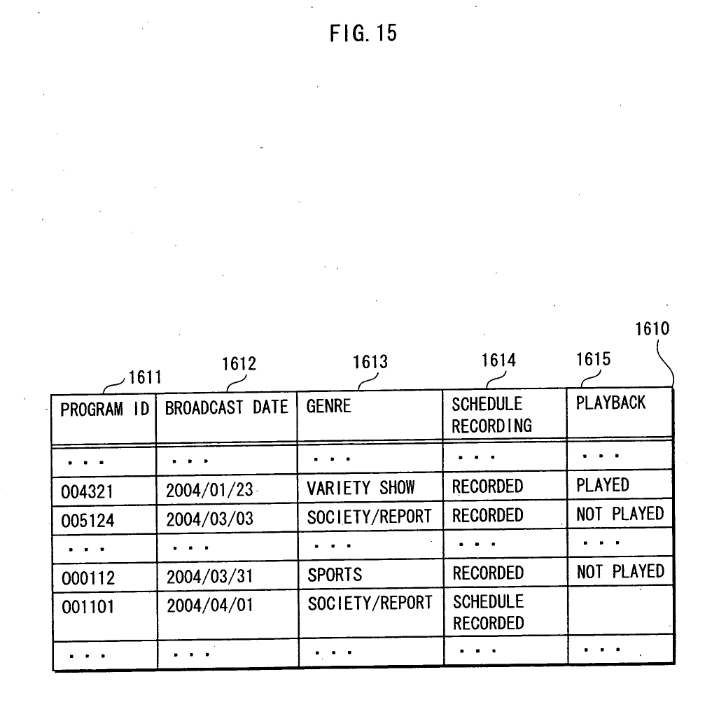

The program information storage unit 1600 has a function of storing program information 9100 (see FIG. 6) which is transmitted from the broadcast station 9000 in regard to programs scheduled to be broadcast, and recorded program information 1610 (see FIG. 15).

The program information 9100 has items such as a broadcast date and time, a synopsis, and a cast, depending on the contents of each program. The program information 9100 includes not only information of a program which is scheduled to be broadcast, but also information of a program which was previously broadcast. A time period covered by the program information 9100 can be determined based on a region, a storage capacity, a viewer instruction, or the like. In this embodiment, the program information 9100 covers a time period from the beginning of the last month to the last day of the broadcast schedule transmitted from the broadcast station 9000.

The recorded program information 1610 is a list of programs including a program which has already been recorded and a program which is scheduled to be recorded.

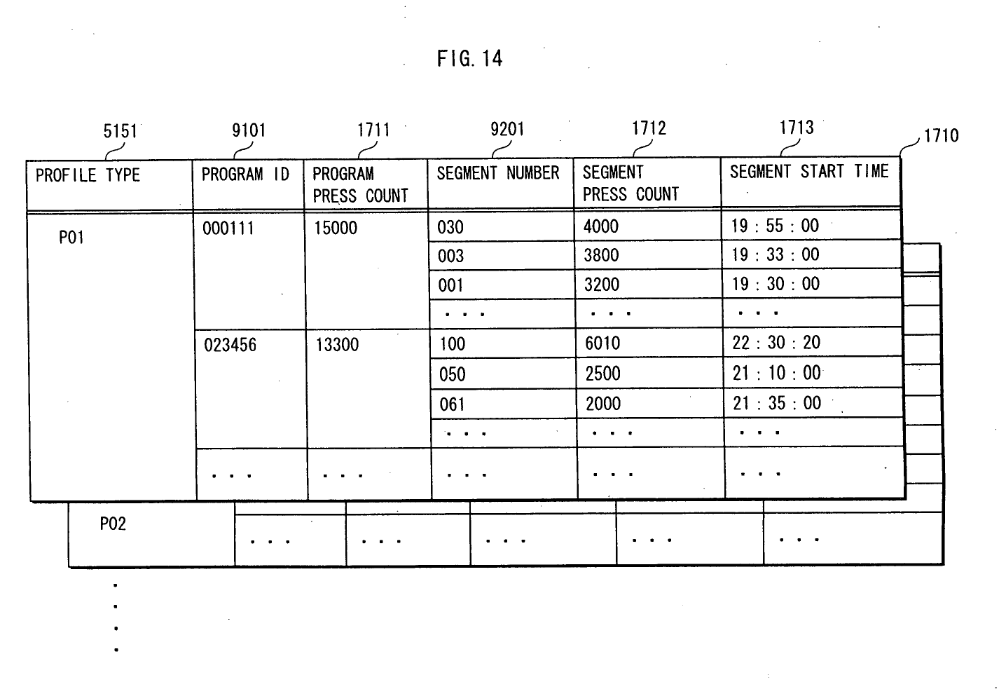

The ranking information storage unit 1700 has a function of storing ranking information 1710 (see FIG. 14) which is a list of recommended programs.

The ranking information 1710 is transmitted from the service provision device 5000 in response to a request when, for example, the viewer performs an operation of displaying the program list screen 2000.

The following explains functional blocks relating to screen display.

The profile information display/edition unit 1100 has a function of reading the profile information 1510 of the viewer stored in the profile information storage unit 1500 and displaying the profile information 1510 on the profile screen 2100. In this embodiment, the profile is displayed using graphics to facilitate visual recognition (see FIG. 3), though the profile may instead be displayed in text.

In more detail, the profile information display/edition unit 1100 selects information corresponding to a profile type to which the profile of the viewer belongs from the profile chart information 1520 stored in the profile information storage unit 1500, and displays the selected information in the form of a hexagonal radar chart.

The profile information display/edition unit 1100 also has a function of receiving edits of the displayed profile. In the case of the chart shown in FIG. 3 as one example, the polygon shape, i.e. the profile, can be changed by moving a data point using a television remote control or the like.

The ranking display unit 1200 has a function of ranking programs recommended to the viewer and displaying the ranking on the program ranking screen 2200.

The recommended programs displayed here are selected by the program selection unit 1800 based on the ranking information 1710 stored in the ranking information storage unit 1700. The ranking display unit 1200 receives information about these recommended programs from the program selection unit 1800, and displays the received information in ranking.

The schedule recorded program display unit 1300 has a function of displaying programs which are scheduled to be recorded, on the schedule recording screen 2300. The schedule recorded program display unit 1300 also has a function of adding or deleting a program on the schedule recording screen 2300 according to an instruction from the viewer.

The schedule recorded programs displayed here are selected by the schedule recorded program display unit 1300 from the recorded program information 1610 stored in the program information storage unit 1600.

The evaluation information input unit 1400 has a function of receiving an input of an evaluation by the viewer on a program which is being played back.

Various evaluation input methods are available, such as using a dedicated external button device attached to the recording/playback device 1000. In this embodiment, the viewer inputs his/her evaluation by pressing a specific key on the television remote control.

Also, various types of evaluations are available. In this embodiment, a high evaluation of a program by the viewer is used as the evaluation. For example, when the viewer finds the program interesting or valuable, he/she presses a corresponding key. Here, if the viewer finds the program more interesting, he/she presses the key more times.

The program selection unit 1800 has a function of selecting a program which is highly evaluated by other viewers, and a function of selecting and schedule recording a program which is scheduled to be broadcast and suits the preferences of the viewer.

The function of selecting a program which is highly evaluated by other viewers is performed as follows. The program selection unit 1800 reads the ranking information 1710 stored in the ranking information storage unit 1700, and selects ranking information that matches the profile of the viewer.

If a program included in the selected ranking information has already been recorded in the recording/playback device 1000, the program selection unit 1800 outputs the ranking information together with information indicating that the program has already been recorded, to the ranking display unit 1200.

The function of selecting a program which is scheduled to be broadcast and suits the preferences of the viewer is performed as follows. The program selection unit 1800 selects a program that is automatically selected according to the preferences of the viewer based on the profile of the viewer, and a program that is included in the ranking information 1710 read from the ranking information storage unit 1700 and is scheduled to be broadcast. The program selection unit 1800 schedule records such selected programs and generates the recorded program information 1610.

The transmission/reception unit 1900 has a function of transferring data with the service provision device 5000.

The chat display unit 1950 has a function of displaying the chat screen 2950 and conversations between registered members on the chat screen 2950.

In this embodiment, a keyboard can be used as a text input medium.

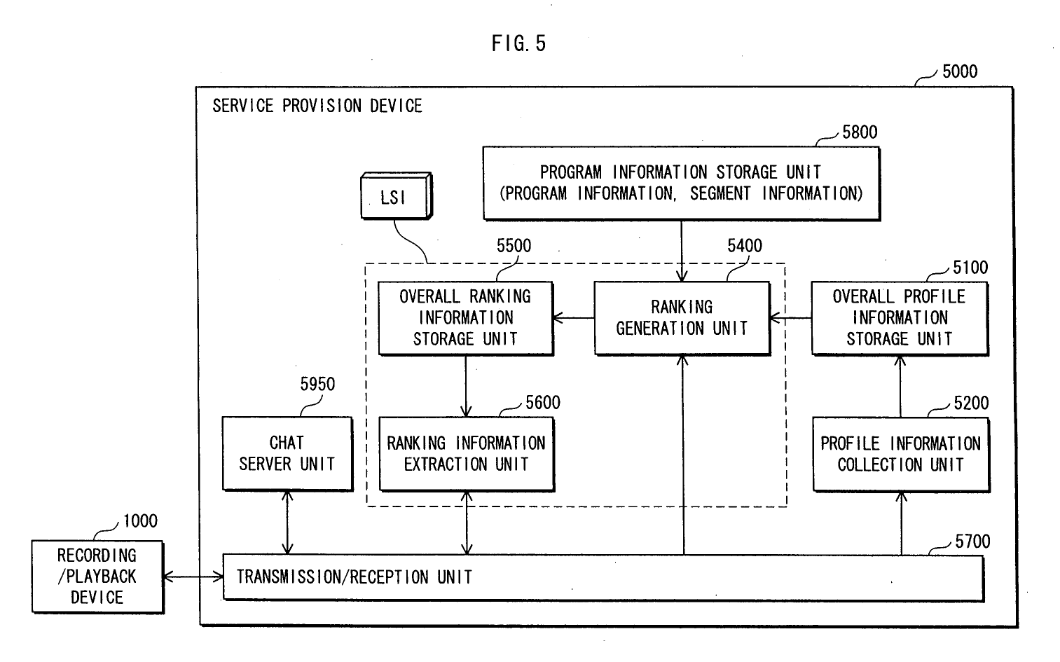

FIG. 5 is a functional block diagram showing a construction of the service provision device.

The service provision device 5000 includes an overall profile information storage unit 5100, a profile information collection unit 5200, a ranking generation unit 5400, an overall ranking information storage unit 5500, a ranking information extraction unit 5600, a program information storage unit 5800, a transmission/reception unit 5700, and a chat server unit 5950.

Each function of the service provision device 5000 can be realized by a CPU executing a program stored on a memory or a hard disk (not illustrated) in the service provision device 5000.

As shown in FIG. 5, the ranking generation unit 5400, the overall ranking information storage unit 5500, and the ranking information extraction unit 5600 are formed by an integrated circuit.

The following explains each of the storage units. Details of information stored in these storage units will be explained later in the <Data> section.

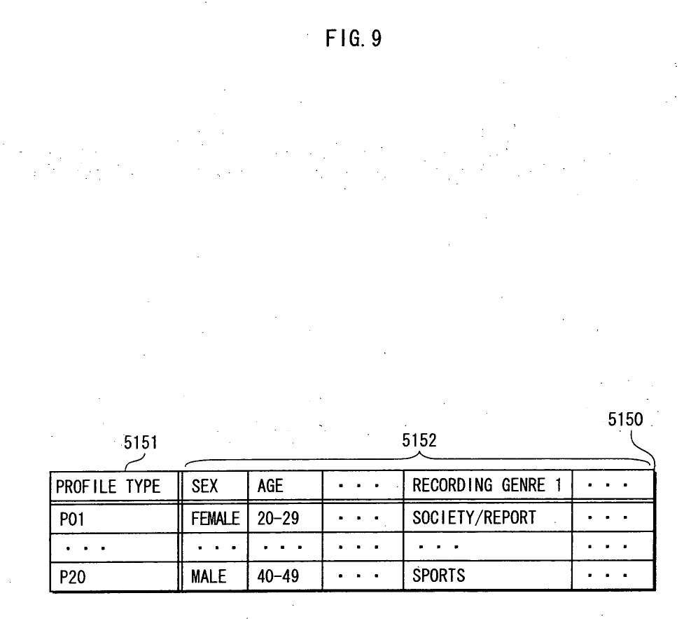

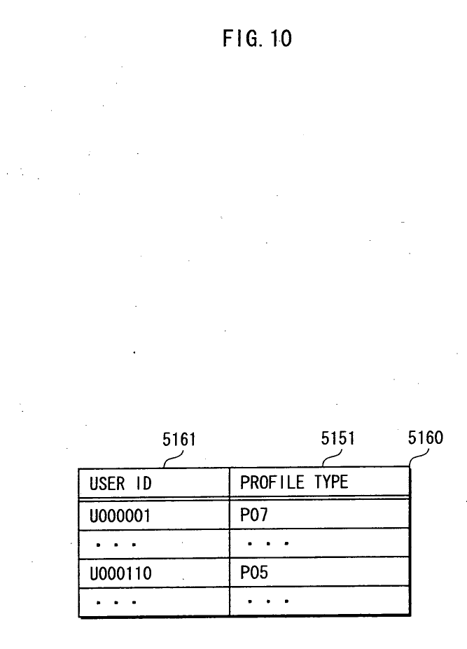

The overall profile information storage unit 5100 has a function of storing profile information 1510 of every viewer, profile type information 5150 (see FIG. 9), a profile type list 5160 (see FIG. 10), and the profile chart information 1520 (see FIG. 11).

The profile information 1510 stored in the overall profile information storage unit 5100 is identical to the profile information stored in the profile information storage unit 1500 in the recording/playback device 1000. The difference from the recording/playback device 1000 is that, while the recording/playback device 1000 stores one set of profile information of the viewer of the recording/playback device 1000, the service provision device 5000 stores a plurality of sets of profile information of all viewers.

The profile type information 5150 is a table for classifying profiles into profile types according to their characteristics. Each viewer is classified into one of the profile types corresponding to his/her profile.

The profile type list 5160 is a table showing a correspondence between a user ID for identifying each viewer and a profile type of the viewer.

The profile chart information 1520 is the same as the profile chart information stored in the profile information storage unit 1500 in the recording/playback device 1000.

The program information storage unit 5800 has a function of storing the program information 9100 that is transmitted from the broadcast station 9000 in regard to programs which are scheduled to be broadcast, and segment information 9200 of each program.

The program information 9100 stored in the program information storage unit 5800 is the same as the program information stored in the program information storage unit 1600 in the recording/playback device 1000.

The segment information 9200 is information about one segment of the program. The segment is one of a plurality of meaningful portions that compose the program. For example, the segment is specified through analysis of closed caption information transmitted together with video and the like of the program, and extraction and analysis of a keyword included in audio of the program.

The overall ranking information storage unit 5500 has a function of storing overall ranking information 5510 which shows evaluations of all programs.

This overall ranking information 5510 includes viewers' evaluations of all programs which have been broadcast and evaluations of segments included in the programs.

The profile information collection unit 5200 has a function of updating, when the profile information 1510 is transmitted from the recording/playback device 1000, profile information in the overall profile information storage unit 5100 that has a same user ID as the received profile information 1510. In detail, the profile information collection unit 5200 judges which profile type a new profile belongs to, and modifies the profile information 1510 and the profile type list 5160.

Here, the profile information is transmitted from the recording/playback device 1000 when the profile information stored in the profile information storage unit 1500 in the recording/playback device 1000 is updated. In the recording/playback device 1000, the profile information is updated either automatically based on the viewing history or when instructed by the viewer.

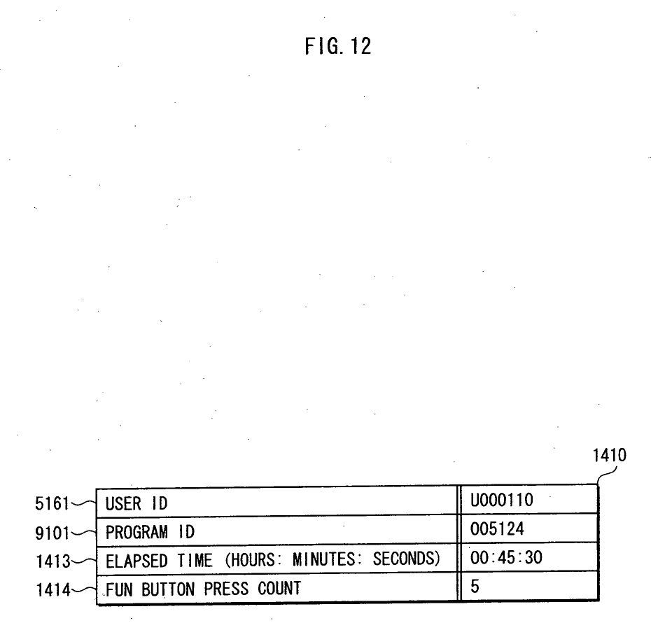

The ranking generation unit 5400 has a function of generating the overall ranking information 5510 based on evaluation information 1410 (see FIG. 12) transmitted from the recording/playback device 1000.

In detail, the ranking generation unit 5400 combines evaluations of each program segment into a total according to profile type, and writes an evaluation total to the overall ranking information storage unit 5500.

The ranking information extraction unit 5600 has a function of extracting information from the overall ranking information storage unit 5500 in response to a request from the recording/playback device 1000, and transmitting the extracted information to the recording/playback device 1000.

This request from the recording/playback device 1000 can be made by, for example, specifying a broadcast time period, a program genre, or a profile. In this embodiment, the request is made by specifying a broadcast time period.

The transmission/reception unit 5700 has a function of transferring data with the recording/playback device 1000.

The chat server unit 5950 has a function of a chat server.

Which is to say, the chat server unit 5950 performs operations such as transmitting a comment of a registered member to all registered members in a chat.

<Data>

The following explains main data used in the program selecting system, with reference to FIGS. 6 to 15.

FIG. 6 shows a structure and a specific example of the program information.

There are various types of program information such as a broadcast program guide transmitted from a television station, a broadcast program guide transmitted from a cable television station, and program information distributed via storage media such as a floppy disk. In this embodiment, the program information 9100 is a list of programs scheduled to be broadcast, which is transmitted from the broadcast station 9000 by text broadcasting or the like.

This information is stored in the program information storage unit 5800 in the service provision device 5000 and the program information storage unit 1600 in the recording/playback device 1000.

The program information 9100 is made up of a program ID 9101, a broadcast date 9102, a broadcast start time 9103, a broadcast end time 9104, a channel 9105, a genre 9106, a title 9107, and program contents 9108.

The program ID 9101 is a number for identifying a program scheduled to be broadcast. In principle, a same number is assigned to programs having a same program title. Even when programs have a same program title, however, different numbers are assigned to the programs if they have different contents as in the case of news. Meanwhile, a rerun of a program is given a same number as the program.

The broadcast date 9102 shows a date on which the program is broadcast. The broadcast start time 9103 and the broadcast end time 9104 respectively show a time at which the broadcasting of the program starts and a time at which the broadcasting of the program ends.

The channel 9105 shows a channel of the program in a region in which the recording/playback device 1000 receives broadcasts.

The genre 9106 shows a genre of the program.

The title 9107 shows a title of the program. This title is displayed on the program list screen.

The program contents 9108 show the contents of the program, such as a synopsis, characters, and a cast.

As one example, a program having the program ID 9101 “005124” is broadcast on channel 255 from 20:00 to 23:00 on Mar. 10, 2004, has a title “Founders in Japan”, and is about the founders who have built global companies.

The broadcast date 9102 to the channel 9105 are information needed mainly when recording the program, and the genre 9106 to the program contents 9108 are information referenced when assessing viewer preferences.

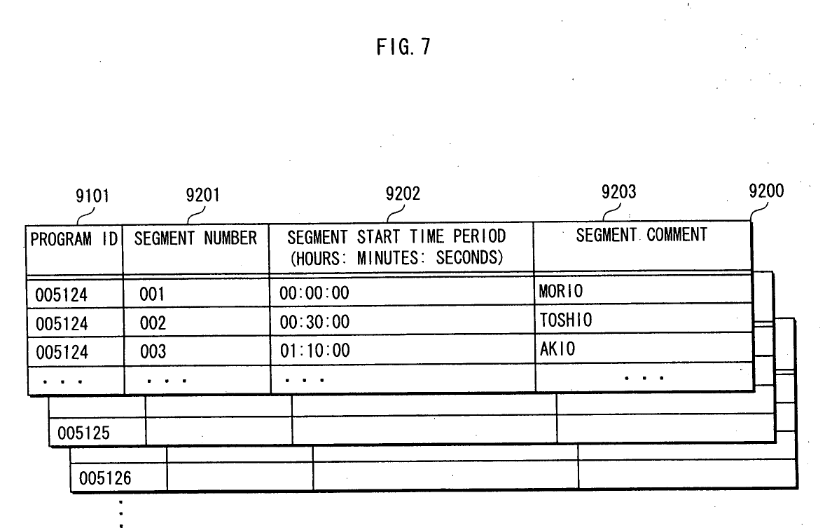

FIG. 7 shows a structure and a specific example of the segment information.

The segment information is provided for each program which has been broadcast.

This information is stored in the program information storage unit 5800 in the service provision device 5000, but is not stored in the program information storage unit 1600 in the recording/playback device 1000.

The segment information 9200 is made up of the program ID 9101, a segment number 9201, a segment start time period 9202, and a segment comment 9203.

The program ID 9101 is the same as the program ID in the program information 9100.

The segment number 9201 is a number for identifying a segment in the program identified by the program ID 9101. Each segment of the program has a different segment number.

The segment start time period 9202 is a time period from the broadcast start time of the program to a point at which the segment starts.

The segment comment 9203 shows a keyword about the segment. For instance, a keyword in captions which is searched for when dividing the program into segments is shown in the segment comment 9203.

As one example, a segment identified by the segment number “002” in the program identified by the program ID “005124” starts “00:30:00”, i.e. 30 minutes, after the start of the program and relates to “Toshio”.

FIG. 8 shows a structure and a specific example of the profile information.

The profile information 1510 is made up of an item 1511 and contents 1512.

The profile information 1510 shows an attribute of a viewer, and includes not only personal information such as sex but also information about a viewing tendency, i.e. what kinds of programs the viewer watches frequently.

As one example, a viewer identified by the user ID “U000110” is a 31-year-old male, and has a viewing tendency in which he most frequently records programs of the “society/report” genre and transmits evaluations of programs of the “sports” genre. This viewing tendency is automatically updated in the recording/playback device 1000 based on the viewing history. When the profile information 1510 in the recording/playback device 1000 is updated, the updated profile information 1510 is transmitted to the service provision device 5000, and the profile information stored in the service provision device 5000 is automatically updated too. In this way, the same profile information is stored in both the recording/playback device 1000 and the service provision device 5000 for the viewer.

Meanwhile, the contents 1512 of the item 1511 “profile type” are determined by the service provision device 5000 and transmitted to the recording/playback device 1000. Upon receiving the profile type, the recording/playback device 1000 updates the contents of the item “profile type” in the profile information 1510.

FIG. 9 shows a structure and a specific example of the profile type information.

The profile type information 5150 shows a criterion for classifying profiles of viewers into profile types. In this embodiment, 20 profile types are provided.

The profile type information 5150 is made up of a profile type 5151 and an item 5152. As one example, the profile type “P01” corresponds to sex “female”, an age group “20-29”, and a most frequently recorded program genre “society/report”.

The reason for classifying each viewer in to these profile types is to select programs which viewers having similar profiles find interesting.

The profile type information 5150 is stored only in the overall profile information storage unit 5100 in the service provision device 5000.

FIG. 10 shows a structure and a specific example of the profile type list.

The profile type list 5160 shows a correspondence between a user ID 5161 of each viewer and the profile type 5151.

For example, when the viewer transmits an evaluation of a program, the profile type list 5160 is used to specify the profile type of the viewer.

The profile type list 5160 is stored only in the overall profile information storage unit 5100 in the service provision device 5000.

FIG. 11 shows a structure and a specific example of the profile chart information.

The profile chart information 1520 is referenced by the profile information display/edition unit 1100 when displaying the profile of the viewer on the profile screen 2100.

The profile chart information 1520 is made up of the profile type 5151 and items 1521. The items 1521 correspond to the items of the chart displayed on the profile screen 2100.

As one example, the chart displayed on the profile screen shown in FIG. 3 corresponds to the profile type 5151 “P05”. Here, a value of each item ranges from “0” (center point) to “100”.

In the case of FIG. 11, a viewer of the profile type “P01” corresponds to love romance “80” and documentary “10”. Each of these values represents a tendency of the viewer watching programs of a corresponding genre. Various methods can be used for such quantification. In this embodiment, 10 is added each time the viewer watches one program of the corresponding genre per week on average based on the viewing history, up to 100 at the maximum. As one example, a viewer of the profile type “P01” has a tendency of viewing eight love romance programs and one documentary program per week.

The profile chart information 1520 is stored in the profile information storage unit 1500 in the recording/playback device 1000 and the overall profile information storage unit 5100 in the service provision device 5000.

FIG. 12 shows a structure and a specific example of the evaluation information.

The evaluation information 1410 is transmitted from the recording/playback device 1000 to the service provision device 5000, when the evaluation information input unit 1400 in the recording/playback device 1000 receives an evaluation from the viewer, that is, when the viewer finds a currently viewed program interesting and presses the corresponding key on the remote control.

The evaluation information 1410 is made up of the user ID 5161, the program ID 9101, an elapsed time 1413, and a fun button press count 1414.

The user ID 5161 is a number for identifying the viewer, and indicates the person who pressed the fun button while watching the program.

The program ID 9101 is a number for identifying the program, and indicates the program which is being played back when the fun button is pressed.

The elapsed time 1413 is a time relative to a playback start time of the program identified by the program ID 9101, i.e. the program which is being played back. The elapsed time 1413 is referenced when specifying a segment in the program.

The fun button press count 1414 shows a number of times the viewer identified by the user ID 5161 presses the button. If an interval between presses is within a predetermined time, these presses are counted cumulatively. A cumulative total of presses is calculated and the program is ranked according to the cumulative total.

In the case of FIG. 12, the viewer identified by the user ID “U000110” presses the fun button “5” times when “00:45:30”, i.e. 45 minutes and 30 seconds, have elapsed from the start of the program identified by the program ID “005124”.

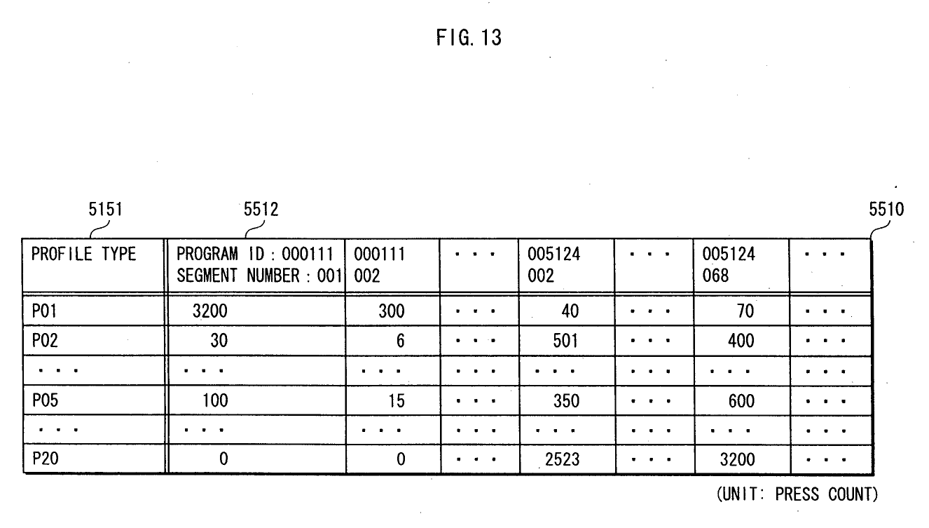

FIG. 13 shows a structure and a specific example of the overall ranking information.

The overall ranking information 5510 totalizes the numbers of presses of the fun button during playback of a segment of a program, for each profile type.

The overall ranking information 5510 is made up of the profile type 5151 and a program ID/segment number 5512.

As one example, during the playback of the segment identified by the segment number “001” in the program identified by the program ID “000111”, the viewers of the profile type “P01” pressed the fun button a total of “3200” times and the viewers of the profile type “P02” pressed the fun button a total of “30” times. This indicates that the viewers of the profile type “P01” found the segment more interesting than the viewers of the profile type “P02”.

The overall ranking information 5510 is stored only in the overall ranking information storage unit 5500 in the service provision device 5000.

Here, since the fun button press count keeps increasing as time passes from the broadcasting of the program, the information about the program is removed from the overall ranking information once a predetermined time period has elapsed from the broadcasting of the program. In this embodiment, the predetermined time period is one month.

FIG. 14 shows a structure and a specific example of the ranking information.

The ranking information 1710 organizes programs and segments in the programs in descending order of fun button press count, for each profile type.

The ranking information 1710 is made up of the profile type 5151, the program ID 9101, a program press count 1711, the segment number 9201, a segment press count 1712, and a segment start time 1713.

The program press count 1711 is a total number of presses of the fun button during the program. The segment press count 1712 is a total number of presses of the fun button during the segment.

The segment start time 1713 is an actual time at which the broadcasting of the segment starts, and is calculated by adding the broadcast start time of the program and the segment start time period. The segment start time is displayed together with the program title when displaying the program ranking on the program ranking screen 2200.

As one example, the program press count 1711 corresponding to the program ID 9101 “000111” is the highest “15000” in the profile type 5151 “P01”. This indicates that the viewers of the profile type “P01” find the program identified by the program ID “00111” most interesting. Likewise, the segment press count 1712 corresponding to the segment number 9201 “030” is the highest “4000” in the profile type 5151 “P01”. This indicates that the viewers of the profile type “P01” find the segment identified by the segment number 9201 “030” most interesting. The segment start time 1713 of this segment is “19:55:00”, that is, the segment starts at 19:55.

The ranking information 1710 is generated by the ranking information extraction unit 5600 in the service provision device 5000 in response to a request from the recording/playback device 1000, and transmitted to the recording/playback device 1000.

This request is made by designating a broadcast time period. For example, when a time period of 30 days before or after today is designated, programs which were broadcast or are scheduled to be broadcast in 30 days before or after today are subjected to the generation of the ranking information 1710.

The ranking information 1710 is stored only in the ranking information storage unit 1700 in the recording/playback device 1000.

FIG. 15 shows a structure and a specific example of the recorded program information.

The recorded program information 1610 is information about a program which has been recorded and a program which is scheduled to be recorded.

The schedule recorded program display unit 1300 reads the recorded program information 1610 stored in the program information storage unit 1600 and displays a list of schedule recorded programs on the schedule recording screen 2300. Also, the program selection unit 1800 references the recorded program information 1610, when judging whether a program displayed by the ranking display unit 1200 has already been recorded.

The recorded program information 1610 is stored only in the program information storage unit 1600 in the recording/playback device 1000.

<Operations>

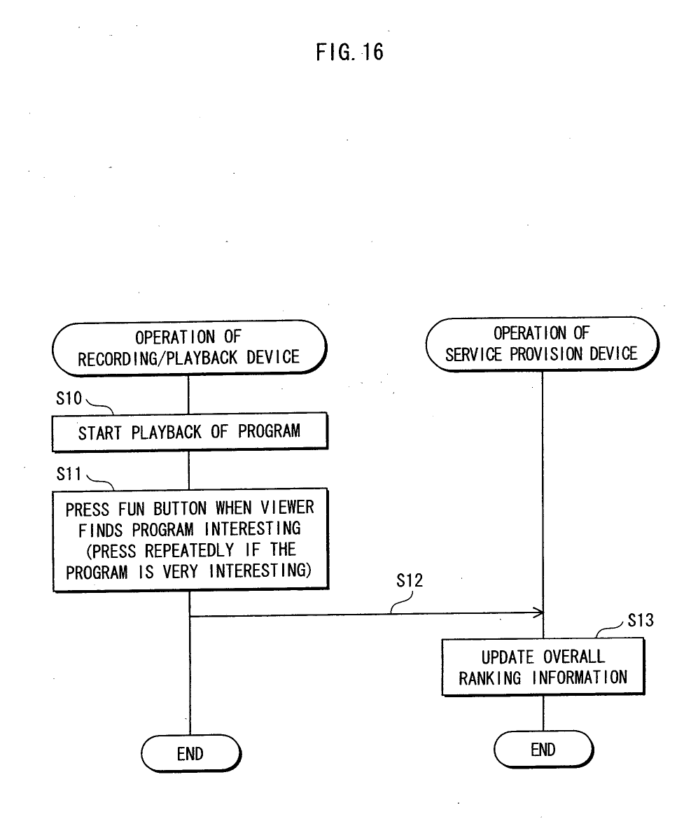

Operations of the program selecting system having the above construction are described below, with reference to FIGS. 16 to 18.

FIG. 16 shows an operation of reflecting the viewer's presses of the fun button onto program ranking.

This operation is performed when each viewer presses the fun button. The numbers of presses of the fun button are combined into a total for each program and for each segment.

The recording/playback device 1000 starts playback of a program (step S10). In detail, upon detecting an instruction from the viewer, the user interface unit 1010 outputs the instruction to the program recording/playback unit 1020, and the program recording/playback unit 1020 responsively plays back the program.

Note here that the playback mentioned in this embodiment includes not only an operation of playing a recorded program but also an operation of receiving a program which is being broadcast and playing the received program.

The viewer watches the program which is being played, and presses the fun button on the remote control when he/she finds the program interesting (step S11).

Upon detecting the press of the fun button, the evaluation information input unit 1400 generates the evaluation information 1410 (see FIG. 12). Here, the user ID 5161 is set to the user ID of the profile information 1510 stored in the profile information storage unit 1500. The program ID 9101 is set to a program ID which is specified using a current date and time and a channel from the program information 9100 stored in the program information storage unit 1600. The elapsed time 1413 is set to a difference between the current time and the broadcast start time 9103 in the program information 9100. The fun button press count 1414 is set to a total number of presses within the predetermined time.

Having generated the evaluation information 1410, the evaluation information input unit 1400 transmits the generated evaluation information 1410 to the service provision device 5000 via the transmission/reception unit 1900 (step S12).

The service provision device 5000 receives the evaluation information 1410 from the recording/playback device 1000, and passes the received evaluation information 1410 to the ranking generation unit 5400 through the transmission/reception unit 5700.

The ranking generation unit 5400 receives the evaluation information 1410, and updates the overall ranking information 5510 stored in the overall ranking information storage unit 5500 based on the received evaluation information 1410 (step S13, see FIG. 13).

First, the ranking generation unit 5400 specifies the profile type 5151 using the user ID 5161 in the evaluation information 1410. To do so, the ranking generation unit 5400 references the profile type list 5160 stored in the overall profile information storage unit 5100. In the example of FIG. 12, the user ID 5161 is “U000110”, so that the profile type 5151 is “P05”.

Next, the ranking generation unit 5400 specifies a segment number from the program ID 9101 and the elapsed time 1413 in the evaluation information 1410. To do so, the ranking generation unit 5400 references the program information 9100 and the segment information 9200 stored in the program information storage unit 5800. In the example of FIG. 12, the elapsed time 1413 from the start of the program identified by the program ID “005124” is “00:45:30”. With reference to the segment start time period 9202 in the segment information 9200, the segment number 9201 corresponding to the elapsed time of 45 minutes and 30 seconds is “002”.

Accordingly, the ranking generation unit 5400 adds the fun button press count 1414 “5” in the evaluation information 1410 to the field with the profile type 5151 “P05”, the program ID “005124”, and the segment number “002” in the overall ranking information 5510. As a result, the corresponding value is changed from “350” to “355”.

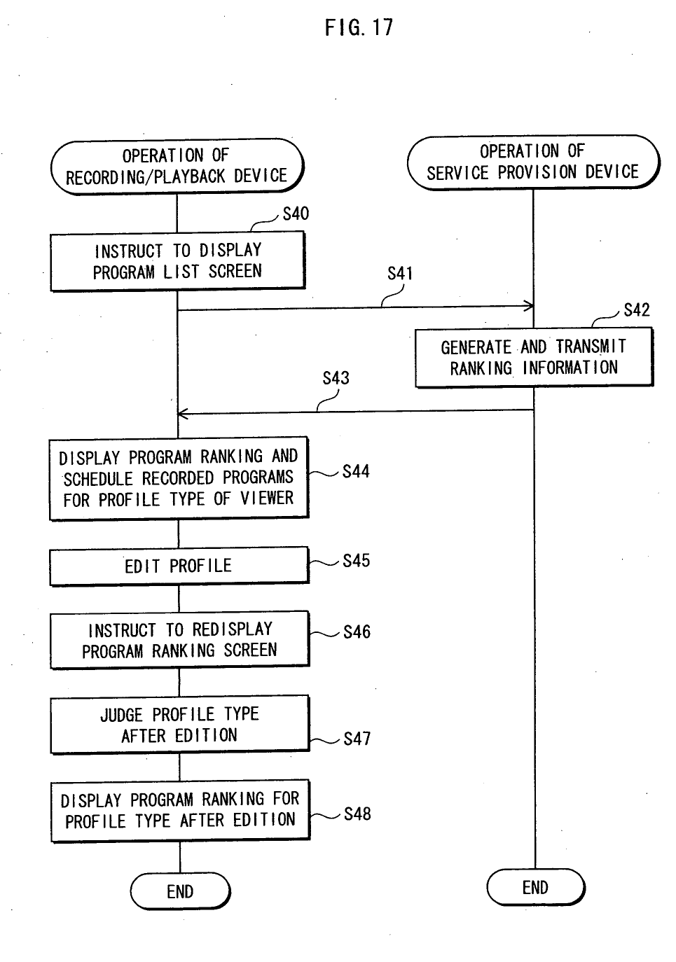

FIG. 17 shows an operation of displaying the program list screen 2000, editing the profile, and redisplaying the program ranking screen 2200.

First, the viewer instructs the recording/playback device 1000 to display the program list screen 2000 (step S40) by, for example, pressing a corresponding button on the remote control.

Upon receiving the instruction to display the program list screen 2000, the recording/playback device 1000 transmits a request to transmit the ranking information 1710 (see FIG. 14), to the service provision device 5000 via the transmission/reception unit 1900 (step S41). When transmitting the ranking information 1710 transmission request, the recording/playback device 1000 designates a time period. For example, if today is March 10, the recording/playback device 1000 designates a time period from February 11 to March 17. The time period used here may be fixed or may be determined by the viewer.

Having received the ranking information 1710 transmission request from the recording/playback device 1000 through the transmission/reception unit 5700, the service provision device 5000 requests the ranking information extraction unit 5600 to extract programs.

Upon receiving the extraction request, the ranking information extraction unit 5600 specifies, for each profile type, programs having high fun button press counts and segments having high fun button press counts in the programs, in the overall ranking information 5510 (see FIG. 13) stored in the overall ranking information storage unit 5500.

The ranking information extraction unit 5600 organizes program IDs of the programs and segment numbers of the segments specified in this way, to generate the ranking information 1710 (step S42).

When doing so, the ranking information extraction unit 5600 includes, in the ranking information 1710, only the programs which are broadcast in the time period designated in the ranking information 1710 transmission request from the recording/playback device 1000. This judgment is made using the program information 9100 (see FIG. 6) stored in the program information storage unit 5800. In the case of the program identified by the program ID “005124” as one example, the broadcast date of the program is “2004/03/10”, so that the ranking information extraction unit 5600 includes this program in the ranking information 1710.

The ranking information extraction unit 5600 also calculates the segment start time 1713 and writes it to the ranking information 1710. The segment start time 1713 is calculated by adding the segment start time period 9202 (see FIG. 7) to the broadcast start time 9103.

The service provision device 5000 transmits the ranking information 1710 generated by the ranking information extraction unit 5600, to the recording/playback device 1000 (step S43).

Upon receiving the ranking information 1710 from the service provision device 5000, the recording/playback device 1000 passes the received ranking information 1710 to the ranking information storage unit 1700 to have the ranking information 1710 stored therein.

The ranking information storage unit 1700 stores the received ranking information 1710.

After storing the ranking information 1710, the recording/playback device 1000 generates a window of the program list screen, and instructs the profile information display/edition unit 1100, the ranking display unit 1200, the schedule recorded program display unit 1300, and the chat display unit 1950 to perform respective display operations (step S44).

Upon receiving the display instruction, the profile information display/edition unit 1100 generates a chart based on the profile chart information 1520 (see FIG. 11) stored in the profile information storage unit 1500, and displays the profile screen 2100 (see FIG. 3).

Here, the profile type of the viewer is specified based on the item “profile type” in the profile information 1510 (see FIG. 8) stored in the profile information storage unit 1500.

Upon receiving the display instruction, the ranking display unit 1200 requests the program selection unit 1800 to select programs corresponding to the profile type of the viewer.

The program selection unit 1800 responsively selects the programs corresponding to the profile type of the viewer from the ranking information 1710 in the ranking information storage unit 1700, and outputs information about the selected programs to the ranking display unit 1200. In more detail, the program selection unit 1800 outputs the program ID 9101 and the segment start time 1713 of each program to be displayed in ranking, to the ranking display unit 1200. When any program to be displayed by the ranking display unit 1200 has already been recorded, the program selection unit 1800 also outputs information indicating that the program has been recorded, to the ranking display unit 1200.

Upon receiving the program ID and the like of each program to be displayed in ranking, the ranking display unit 1200 displays a broadcast date, a program title, a broadcast start time, a segment start time, a REC mark, and the like on the ranking screen 2200 based on the program ID.

Here, the profile type of the viewer is specified by referring to the item “profile type” in the profile information 1510.

Also, the judgment as to whether the program has already been recorded or not is made by referring to the recorded program information 1610 (see FIG. 15) stored in the program information storage unit 1600. If the schedule recording 1614 shows “recorded”, the program has already been recorded.

Upon receiving the display instruction, the schedule recorded program display unit 1300 reads information of each program which is scheduled to be recorded from today on, from the recorded program information 1610 (see FIG. 15) stored in the program information storage unit 1600. The schedule recorded program display unit 1300 then displays the schedule recording screen 2300.

The chat display unit 1950 displays a chat window.

Thus, the program list screen 2000 is displayed.

The viewer can play back and view a program that is displayed on the ranking screen 2200 and is marked as “REC”. When doing so, the viewer can start the playback of the program from the beginning or from a highly-evaluated segment, through a button operation on the remote control.

Upon detecting the button operation by the viewer, the user interface unit 1010 instructs the program recording/playback unit 1020 to play the recorded program. Here, the user interface unit 1010 extracts a start time of the program and segment to be played back from the information displayed by the ranking display unit 1200, and notifies the start time to the program recording/playback unit 1020.

The following explains an operation of editing the chart on the profile screen 2100 and redisplaying the program ranking screen 2200 for the viewer of the edited profile.

The viewer edits the chart (see FIGS. 2 and 3) displayed on the profile screen 2100 (step S45). For example, the profile of the viewer can be changed to a profile of frequently viewing daytime programs, by increasing the value of “day” on the chart.

After the chart is edited, the recording/playback device 1000 receives an instruction to redisplay the program ranking screen 2200 from the viewer (step S46). The recording/playback device 1000 specifies a profile type that is closest to the edited profile in the profile chart information 1520 stored in the profile information storage unit 1500 (step S47).

Following this, the recording/playback device 1000 instructs the ranking display unit 1200 to display program ranking corresponding to the edited profile. The ranking display unit 1200 accordingly displays the program ranking screen 2200 (step S48). The operation of the ranking display unit 1200 here is the same as the one performed in step S44, except that not the profile type shown in the profile information 1510 but the profile type specified after the edition is used.

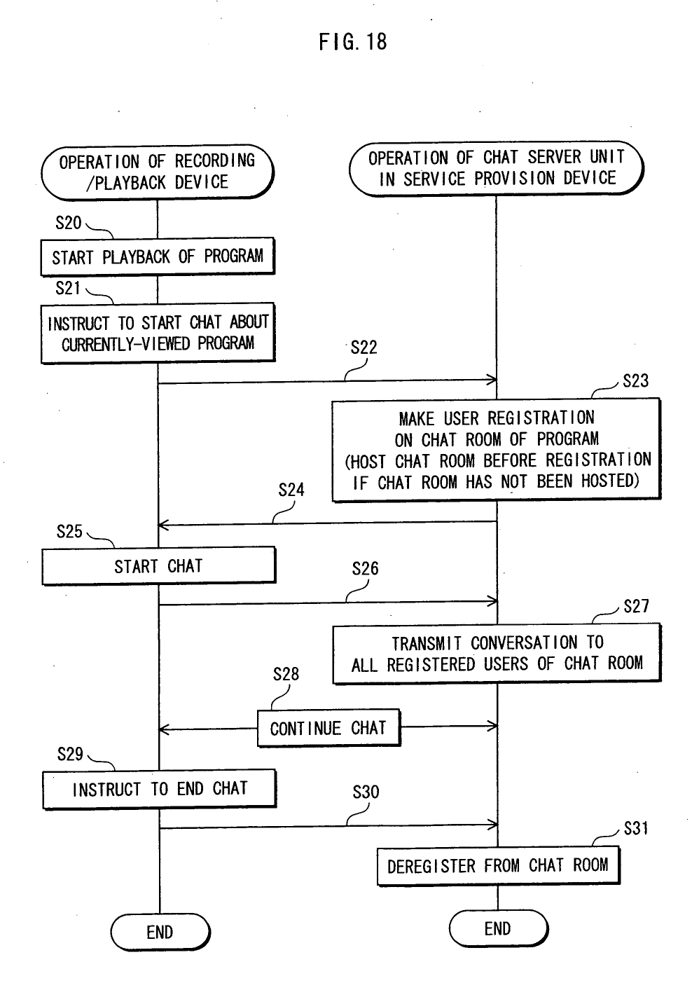

FIG. 18 shows an operation of performing a chat.

The recording/playback device 1000 starts playback of a program (step S20).

In principle, the playback mentioned here is an operation of receiving a program which is being broadcast and playing the received program. This is because the progress of the program should preferably be coincident between viewers when performing a chat. If the playback start time is the same between viewers, however, the playback may include an operation of playing a recorded program.

The recording/playback device 1000 receives an instruction to perform a chat from the viewer who is viewing the program (step S21), and instructs the chat display unit 1950 to display conversations on the chat screen 2950.

Upon receipt of the instruction to display conversations on the chat screen 2950, the chat display unit 1950 requests the chat server unit 5950 in the service provision device 5000 to make registration (step S22).

When making the registration request, the chat display unit 1950 transmits the program ID 9101 of the program being played back and the user ID in the profile information 1510.

Having received the registration request, the chat server unit 5950 checks whether a chat room corresponding to the program identified by the received program ID has been hosted. If the chat room has been hosted, the chat server unit 5950 registers the received user ID. If the chat room has not been hosted, the chat server unit 5950 hosts the chat room and then registers the received user ID (step S23).

After registering the received user ID to the chat room, the chat server unit 5950 notifies the recording/playback device 1000 of the completion of the registration (step S24).

The recording/playback device 1000 receives the notification of the registration of the user ID, and notifies the chat display unit 1950 of the registration. This completes a preparation for initiating a chat.

An alias of the user ID or the like is displayed on the chat screen, and the viewer performs a chat with other viewers (step S28).

After the chat, the recording/playback device 1000 receives an instruction to end the chat from the viewer (step S29), and passes the instruction to the chat server unit 5950 (step S30). When doing so, the recording/playback device 1000 notifies the chat server unit 5950 of the user ID.

Upon receiving the instruction to end the chat, the chat server unit 5950 deregisters the received user ID (step S31), thereby ending the chat.

The chat server unit 5950 generates the evaluation information 1410 (see FIG. 12) and outputs it to the ranking generation unit 5400, each time the chat server unit 5950 receives a chat conversation from the viewer.

As one example, the fun button press count 1414 of the evaluation information 1410 generated here is “1”. The elapsed time 1413 is notified by the service provision device 5000. Here, the service provision device 5000 counts a time from the broadcast start time of the program.

The ranking generation unit 5400 receives the evaluation information 1410, and processes the evaluation information 1410 in the same way as the evaluation information 1410 transmitted from the recording/playback device 1000, to reflect it onto the overall ranking information 5510 (see step S13 in FIG. 16).

<Modifications>

Although the program selecting system according to the present invention has been described by way of the embodiment, the present invention is not limited to the above, as the embodiment can partly be modified as follows.

(1) The embodiment describes the case where a keyboard is used as a text input medium when performing a chat, but other text input media are equally applicable. For example, a mobile phone may be used. In this case, the mobile phone and the recording/playback device need to be set so as to be able to transfer data by radio.

(2) The embodiment describes the case where the attribute information of the viewer is stored in both the recording/playback device and the service provision device, but the attribute information of the viewer may be stored only in the service provision device.

In this case, it is necessary to set an identifier for identifying the recording/playback device and store this identifier in the service provision device in correspondence with the attribute information of the viewer of the recording/playback device.

(3) The embodiment describes the case where profiles of viewers are classified into profile types and viewers having a same profile type are regarded as having a same attribute. However, the judgment as to whether viewers have a same attribute or not may be made in a different manner.

For example, each item of the profile of the viewer is expressed as a score, and a difference in total score between viewers is within a predetermined value, these viewers are judged as having a same attribute.

(4) The embodiment may be modified such that, when displaying the program ranking on the program ranking screen, the display may be limited to specific programs. For instance, though the embodiment marks a program which has already been recorded as “REC” in the program ranking screen, only already recorded programs may be displayed on the program ranking screen.

In this case, the program selection unit 1800 selects only programs corresponding to the schedule recording 1614 “recorded” in the recorded program information 1610. This is advantageous in that the viewer can watch a ranked program at once.

(5) The embodiment describes the case where a program is removed from the overall ranking information one month after the broadcast date of the program, but this time period may be varied depending on a genre of the program, such as one week in the case of news. Also, the time period need not be set relative to the broadcast date. Furthermore, the program may be removed from the overall ranking information according to other rules. As one example, the program is removed from the overall ranking information if the fun button press count within one week from the broadcast date is 0.

(6) The embodiment describes the case where the recording/playback device 1000 transmits the ranking information 1710 transmission request to the service provision device 5000 only when the viewer makes the program list screen display instruction (step S40 in FIG. 17), but the present invention is not limited to this. For example, the recording/playback device 1000 may also transmit the ranking information 1710 transmission request to the service provision device 5000 upon receiving the program ranking screen redisplay instruction (step S46). In this case, the request for the ranking information is made by indicating the profile type. This has an advantage of reducing a size of data transferred and a processing load of the service provision device, though a traffic jam could be caused by concentration of requests from many recording/playback devices.

(7) The embodiment describes an example where the number of viewers of the recording/playback device 1000 is one for the sake of convenience, but the number of viewers may be more than one depending on a family structure or the like.

In such a case, each viewer of the recording/playback device 1000 needs to be identified using an ID for identifying the viewer, his/her own remote control, and the like.

Also, the present invention may be applied to a general home network, in such a manner that evaluations are summarized in each home using a home server and a totalization result is transmitted to an external server. In the embodiment, an evaluation is transmitted from each recording/playback device 1000 to the service provision device 5000. In this modification, on the other hand, a summarized evaluation is transmitted from each home to the service provision device 5000.

By applying the present invention to a general home network, the following advantage can be attained as one example. After coming home, a father can view all program segments which someone in a family found interesting.

(8) A program for having a CPU execute each control procedure (such as the one shown in FIG. 16) for achieving each function of the program selecting system described in the embodiment may be distributed having been stored on a storage medium or via a communication path. Examples of the storage medium include an IC card, an optical disc, a flexible disk, a ROM, and a flash memory. The distributed program is stored in a CPU readable memory or the like in a device and put to use. Each function of the program selecting system described in the embodiment can be realized by the CPU executing this program.

(9) The embodiment describes the case where functional units such as the program selection unit 1800 in the recording/playback device 1000 are formed by an integrated circuit, but these functional units may individually be formed in one chip. Alternatively, an integrated circuit in which the other functional units shown in FIG. 4 are formed in one chip together with the functional units such as the program selection unit 1800 may be employed.

Likewise, the embodiment describes the case where functional units such as the ranking generation unit 5400 in the service provision device 5000 are formed by an integrated circuit, but these functional units may individually be formed in one chip. Alternatively, an integrated circuit in which the other functional units shown in FIG. 5 are formed in one chip together with the functional units such as the ranking generation unit 5400 may be employed.

It should be noted here that the integrated circuit may be called an IC or an LSI depending on a component integration degree.

Also, a dedicated circuit or a general-purpose processor may be used as an integrated circuit device. An FPGA (Field Programmable Gate Array) whose architecture is changeable and a reconfigurable processor are applicable too. If a new technique that can replace the conventional semiconductor integrated circuit is developed as a result of the advance of technologies in the future, such a technique can of course be used. For example, biotechnology may be adopted for integrated circuits.

### INDUSTRIAL APPLICABILITY

The present invention is useful as a technique of not only presenting programs that better suit viewer preferences, but also assessing evaluations of programs according to viewer profile type and reflecting the assessment on program generation and the like.

1. A program selecting system including a server device and a plurality of playback devices,
the server device comprising:
an acquisition unit operable to acquire, from each playback device, a program identifier for identifying a program being played back, an elapsed time information piece showing an elapsed time from a start of the program, an evaluation of the program by a viewer, and attribute information showing an attribute of the viewer;
a storage unit operable to store, for each of a plurality of viewer types based on attributes, evaluation totals in correspondence with program identifiers and elapsed time information pieces, each evaluation total being a result of totalizing evaluations acquired together with a corresponding program identifier and elapsed time information piece;
a specific attribute acquisition unit operable to acquire specific attribute information;
a selection unit operable to select program identifiers and elapsed time information pieces stored in the storage unit for a viewer type determined by the specific attribute information; and
a transmission unit operable to transmit the selected program identifiers and elapsed time information pieces, and evaluation totals corresponding to the selected program identifiers and elapsed time information pieces, and
each playback device comprising:
a playback unit operable to play back the program;
a transmitting unit operable to transmit, while the program is being played back, the program identifier, the elapsed time information-piece, the evaluation, and the attribute information to the server device;
a specific attribute transmission unit operable to transmit the specific attribute information;
a program acquisition unit operable to acquire, from the server device, the program identifiers and elapsed time information pieces selected in relation to the specific attribute information, and the evaluation totals corresponding to the selected program identifiers and elapsed time information pieces; and
a display unit operable to display the acquired program identifiers and elapsed time information pieces, in an order based on the acquired evaluation totals.

2. A program playback device comprising:
a playback unit operable to play back a program;
a transmitting unit operable to transmit, while the program is being played back, a program identifier for identifying the program, an elapsed time information piece showing an elapsed time from a start of the program, an evaluation of the program by a viewer, and attribute information showing an attribute of the viewer, to an external device that collects program identifiers, elapsed time information pieces, evaluations, and attribute information from a plurality of playback devices including the program playback device;
an acquisition unit operable to acquire, from the external device, program identifiers and elapsed time information pieces that relate to the attribute information, and evaluations corresponding to the program identifiers and elapsed time information pieces that relate to the attribute information; and
a display unit operable to display the acquired program identifiers and elapsed time information pieces, in an order based on the acquired evaluations.

3. The program playback device of claim 2 further comprising:
a recording unit operable to record a program to a storage medium,
wherein if a program identified by any of the acquired program identifiers has already been recorded by the recording unit, the display unit displays, together with the program identifier, information that the program identified by the program identifier has already been recorded.

4. The program playback device of claim 2 further comprising:
a playback instruction unit operable to choose a program identifier and an elapsed time information piece from the display by the display unit, and obtain a playback instruction,
wherein the playback unit starts playing back a program identified by the chosen program identifier, from a point specified by the chosen elapsed time information piece relative to a start of the program.

5. The program playback device of claim 2 further comprising:
an attribute display unit operable to display the attribute information;
an attribute edition unit operable to edit the attribute information displayed by the attribute display unit; and
an edited attribute transmission unit operable to transmit the edited attribute information to the external device,
wherein the acquisition unit acquires, from the external device, program identifiers and elapsed time information pieces that relate to the edited attribute information, and evaluations corresponding to the program identifiers and elapsed time information pieces that relate to the edited attribute information.

6. The program playback device of claim 5,
wherein the attribute display unit quantifies the attribute information and displays the quantified attribute information in a chart.

7. The program selecting system of claim 1 further including a chat server,
wherein each playback device further comprises:
a chat window used to perform a chat about the program being played back; and
a text input device,
if a chat room for the program has not been hosted, the chat server hosts the chat room, and
the evaluation is an amount of conversation made in the chat.

8. A server device comprising:
an acquisition unit operable to acquire, from each of a plurality of playback devices, a program identifier for identifying a program being played back, an elapsed time information piece showing an elapsed time from a start of the program, an evaluation of the program by a viewer, and attribute information showing an attribute of the viewer;
a storage unit operable to store, for each of a plurality of viewer types based on attributes, evaluation totals in correspondence with program identifiers and elapsed time information pieces, each evaluation total being a result of totalizing evaluations acquired together with a corresponding program identifier and elapsed time information piece;
a specific attribute acquisition unit operable to acquire specific attribute information;
a selection unit operable to select program identifiers and elapsed time information pieces stored in the storage unit for a viewer type determined by the specific attribute information; and
a transmission unit operable to transmit the selected program identifiers and elapsed time information pieces.

9. A program display method used in a device for playing back a program, comprising steps of:
playing back a program;
transmitting, while the program is being played back, a program identifier for identifying the program, an elapsed time information piece showing an elapsed time from a start of the program, an evaluation of the program by a viewer, and attribute information showing an attribute of the viewer, to an external device that collects program identifiers, elapsed time information pieces, evaluations, and attribute information from a plurality of playback devices including the device;
acquiring, from the external device, program identifiers and elapsed time information pieces that relate to the attribute information, and evaluations corresponding to the program identifiers and elapsed time information pieces that relate to the attribute information; and
displaying the acquired program identifiers and elapsed time information pieces, in an order based on the acquired evaluations.

10. A computer program for causing a device for playing back a program to perform a program display operation, the program display operation comprising steps of:
playing back a program;
transmitting, while the program is being played back, a program identifier for identifying the program, an elapsed time information piece showing an elapsed time from a start of the program, an evaluation of the program by a viewer, and attribute information showing an attribute of the viewer, to an external device that collects program identifiers, elapsed time information pieces, evaluations, and attribute information from a plurality of playback devices including the device;
acquiring, from the external device, program identifiers and elapsed time information pieces that relate to the attribute information, and evaluations corresponding to the program identifiers and elapsed time information pieces that relate to the attribute information; and
displaying the acquired program identifiers and elapsed time information pieces, in an order based on the acquired evaluations.

11. A computer program for causing a server device to perform a program management operation, the program management operation comprising steps of:
acquiring, from each of a plurality of playback devices, a program identifier for identifying a program being played back, an elapsed time information piece showing an elapsed time from a start of the program, an evaluation of the program by a viewer, and attribute information showing an attribute of the viewer;
storing, for each of a plurality of viewer types based on attributes, evaluation totals in correspondence with program identifiers and elapsed time information pieces, each evaluation total being a result of totalizing evaluations acquired together with a corresponding program identifier and elapsed time information piece;
acquiring specific attribute information;
selecting program identifiers and elapsed time information pieces stored for a viewer type determined by the specific attribute information; and
transmitting the selected program identifiers and elapsed time information pieces.

12. An integrated circuit for a playback device for playing back a program, comprising:
a transmitting unit operable to transmit, while a program is being played back, a program identifier for identifying the program, an elapsed time information piece showing an elapsed time from a start of the program, an evaluation of the program by a viewer, and attribute information showing an attribute of the viewer, to an external device that collects program identifiers, elapsed time information pieces, evaluations, and attribute information from a plurality of playback devices including the playback device;
an acquisition unit operable to acquire, from the external device, program identifiers and elapsed time information pieces that relate to the attribute information, and evaluations corresponding to the program identifiers and elapsed time information pieces that relate to the attribute information; and
a display unit operable to display the acquired program identifiers and elapsed time information pieces, in an order based on the acquired evaluations.

13. An integrated circuit for a server device, comprising:
an acquisition unit operable to acquire, from each of a plurality of playback devices, a program identifier for identifying a program being played back, an elapsed time information piece showing an elapsed time from a start of the program, an evaluation of the program by a viewer, and attribute information showing an attribute of the viewer;
a storage unit operable to store, for each of a plurality of viewer types based on attributes, evaluation totals in correspondence with program identifiers and elapsed time information pieces, each evaluation total being a result of totalizing evaluations acquired together with a corresponding program identifier and elapsed time information piece;
a specific attribute acquisition unit operable to acquire specific attribute information;
a selection unit operable to select program identifiers and elapsed time information pieces stored in the storage unit for a viewer type determined by the specific attribute information; and
a transmission unit operable to transmit the selected program identifiers and elapsed time information pieces.
